(19) United States
(12) Patent Application Publication
(10) Pub. No.: US 2021/0178721 A1
(43) Pub. Date: Jun. 17, 2021

(54) FOOD CARTON INSERT AND METHODS FOR PROVIDING MULTIPLE FOOD COMPARTMENTS IN A FOOD CONTAINER

(71) Applicant: Inno-Pak, LLC, Delaware, OH (US)

(72) Inventor: Steven A. Mayer, Indianapolis, IN (US)

(73) Assignee: Inno-Pak, LLC, Delaware, OH (US)

(21) Appl. No.: 17/121,694

(22) Filed: Dec. 14, 2020

Related U.S. Application Data
(60) Provisional application No. 62/947,143, filed on Dec. 12, 2019.

(51) Int. Cl. B31D 5/00; B65D 5/49

(52) U.S. Cl. CPC B31D 5/0004; B31B 2120/25; B65D 5/48042

(57) ABSTRACT

A food carton insert and methods for providing multiple food compartments in a food container is disclosed. The food carton insert may be used for rendering one large compartment of an existing food carton or container into multiple smaller food compartments. In some embodiments, the presently disclosed food carton insert may be a substantially continuous sheet of paperboard that is folded in a manner that provides at least two food compartments separated by a divider. Additionally, a method of making the presently disclosed food carton insert is provided. Further, a method of using the presently disclosed food carton insert is provided.

### CROSS-REFERENCE TO RELATED APPLICATIONS

This application claims priority to U.S. Patent Application 62/947,143 filed Dec. 12, 2019, the contents of which are hereby incorporated by reference in its entirety.

### TECHNICAL FIELD

The presently disclosed subject matter relates generally to carry-out food containers and more particularly to a food carton insert and methods for providing multiple food compartments in a food container.

### BACKGROUND

Various products are known to be purchased by consumers which require a container for ease of transport. For example, in the food and grocery industry it is common to place food items in individual carry-out/to-go food containers. There may be certain drawbacks to commonly used carry-out food containers. For example, often the carry-out food container provides one compartment only for holding food. Consequently, when multiple food items are placed in the food container, the one compartment offers no means for keeping the multiple food items separate.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Further, the claimed subject matter is not limited to implementations that solve any or all disadvantages noted in any part of this disclosure.

According to at least one embodiment of the disclosed subject matter, a method of making a food carton insert, including: providing a substantially continuous sheet of paperboard having a first end and a second end opposite the first end; folding the paperboard at a first fold line at a 90-degree angle in a first direction; folding the paperboard at a second fold line at a 180-degree angle in a second direction being opposite the first direction; folding the paperboard at a third fold line at a 90-degree angle in the first direction for creating a divider between the first fold line and the third fold line, thereby creating a first food compartment left of the divider and a second food compartment right of the divider.

According to at least another embodiment of the disclosed subject matter, the method of making a food carton insert further includes wherein the third fold line fold is folded after the second fold line fold, which is folded after the first fold line fold.

According to at least another embodiment of the disclosed subject matter, the method of making a food carton insert further includes applying adhesive to one or two opposing panels of the paperboard extending from the second fold line, and applying pressure to adhere the two opposing panels together.

According to at least another embodiment of the disclosed subject matter, the method of making a food carton insert further includes indenting or scoring the first fold line and the third fold line on a top side of the paperboard.

According to at least another embodiment of the disclosed subject matter, the method of making a food carton insert further includes indenting or scoring the second fold line on a bottom side of the paperboard.

According to at least another embodiment of the disclosed subject matter, the method of making a food carton insert further includes perforating one of more of the fold lines of the paperboard.

According to at least another embodiment of the disclosed subject matter, the method of making a food carton insert further includes: folding the paperboard at a fourth fold line at a 90-degree angle in the first direction; folding the paperboard at a fifth fold line at a 180-degree angle in the second direction; folding the paperboard at a sixth fold line at a 90-degree angle in the first direction for creating a second divider between the fourth fold line and the sixth fold line, thereby creating a third food compartment right of the second divider.

According to at least another embodiment of the disclosed subject matter, the method of making a food carton insert further includes: folding the paperboard at a seventh fold line at a 90-degree angle in the first direction; folding the paperboard at an eight fold line at a 180-degree angle in the second direction; folding the paperboard at a ninth fold line at a 90-degree angle in the first direction for creating a third divider between the seventh fold line and the ninth fold line, thereby creating a fourth food compartment right of the third divider.

According to at least another embodiment of the disclosed subject matter, the method of making a food carton insert further includes: placing the food carton insert into a food carton or container; placing food in one or more of the compartments; closing the food carton or container.

### BRIEF DESCRIPTION OF THE DRAWINGS

The foregoing, as well as the following Detailed Description of preferred embodiments, is better understood when read in conjunction with the appended drawings. For the purposes of illustration, there is shown in the drawings exemplary embodiments; however, the presently disclosed subject matter is not limited to the specific methods and instrumentalities disclosed.

FIG. 1 illustrates a perspective view of an example of the presently disclosed food carton insert for providing multiple food compartments in a food container, which is a three-compartment food carton insert.

FIG. 2 illustrates a perspective view of the three-compartment food carton insert shown in FIG. 1 installed in a food carton or container.

FIG. 3 illustrates a plan view of the three-compartment food carton insert shown in FIG. 1 in a flat pre-folded configuration.

FIG. 4 illustrates a plan view of a four-compartment food carton insert.

FIG. 5 illustrates a perspective view of yet another example of the presently disclosed food carton insert for providing multiple food compartments in a food container, which is a two-compartment food carton insert according to a simplest configuration.

FIG. 6 illustrates a perspective view of the two-compartment food carton insert shown in FIG. 5 installed in a food carton or container.

FIG. 7 illustrates a flow diagram of an example of a method of making the presently disclosed food carton insert for providing multiple food compartments in a food container.

FIG. 8 illustrates a flow diagram of an example of a method of using the presently disclosed food carton insert for providing multiple food compartments in a food container.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

In some embodiments, the presently disclosed subject matter provides a food carton insert and methods for providing multiple food compartments in a food container. The presently disclosed food carton insert may be easily installed in an existing food carton or container. For example, the presently disclosed food carton insert may be used for rendering one large compartment of an existing food carton or container into multiple food compartments.

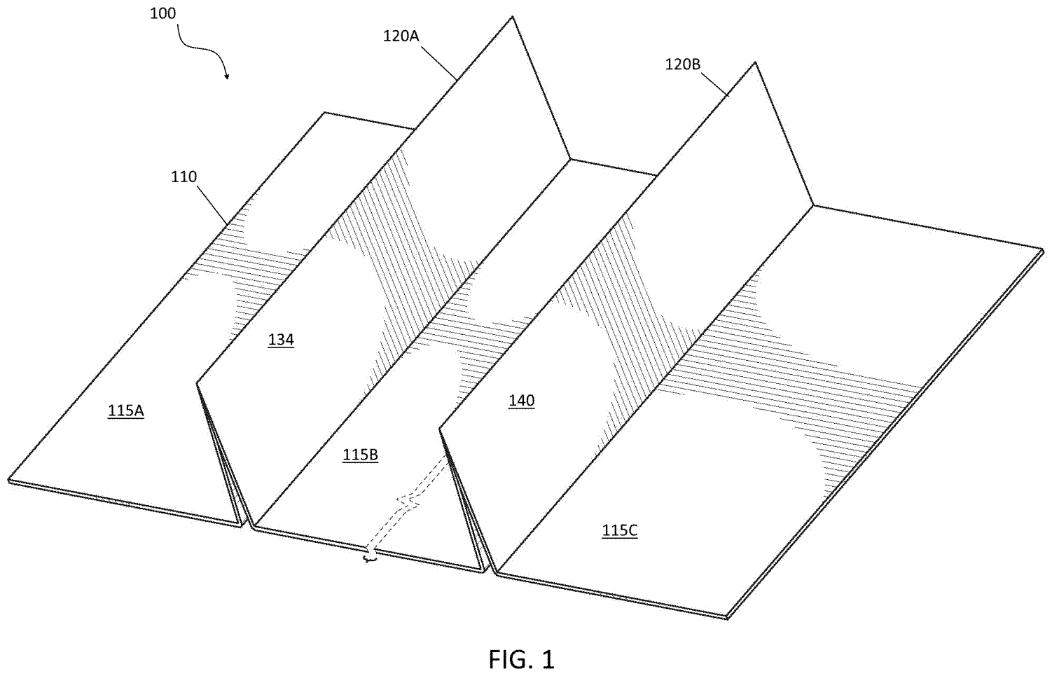

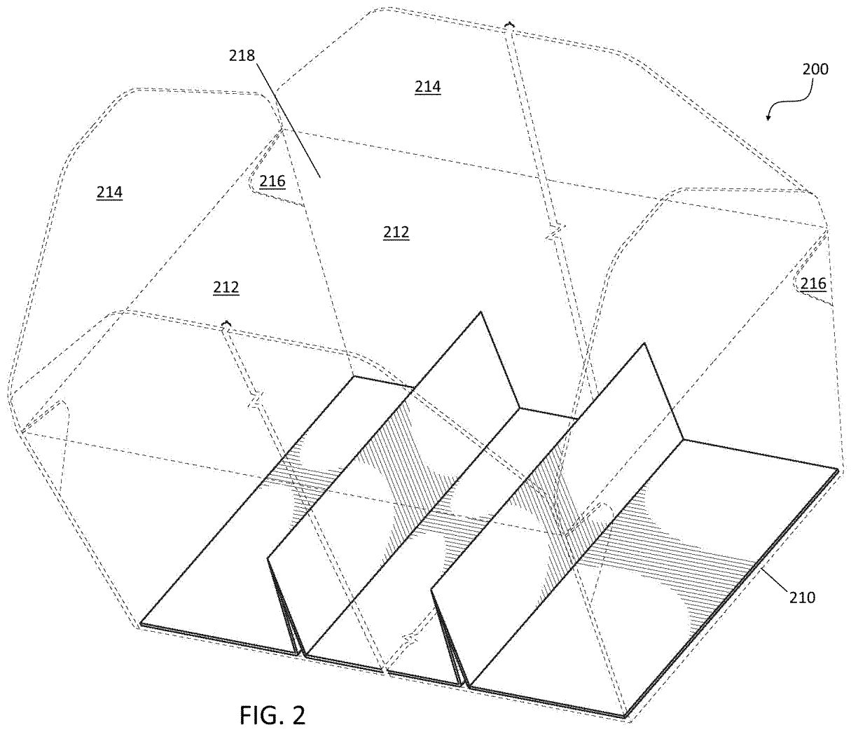

Referring now to FIG. 1 is a perspective view of an example of the presently disclosed food carton insert 100 for providing multiple food compartments in a food container, which in this non-limiting example is shown as a three-compartment food carton insert 100. Notably, FIG. 1 depicts a three-compartment food carton insert 100, though the dotted lines in the middle insert allow for the possibility that numerous additional compartments 115 may be envisioned. Similarly, FIG. 2 allows for the possibility of additional compartments 115 and/or a longer food carton 200.

Food carton insert 100 may be formed from a continuous panel 110 that is foldable. When folded, foldable panel 110 may provide multiple food compartments 115 separated by dividers 120. The dividers 120 are formed of a folded portion of panel 110. In the example of the three-compartment food carton insert 100, food carton insert 100 may include three food compartments 115 (e.g., food compartments 115A, 115B, 115C) separated by two dividers 120 (e.g., dividers 120A, 120B).

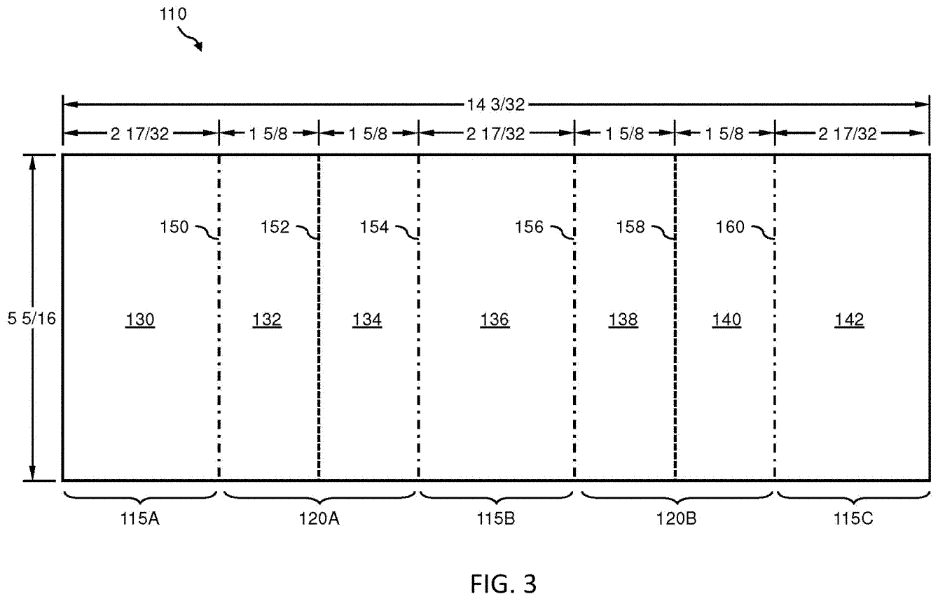

Panel 110 may be formed, for example, of paperboard. Paperboard is a thick, paper-based material used, for example, for packaging. Paperboard is the broad name that refers to different qualities, or grades, of paper-based packaging material. Further, the paperboard forming panel 110 may be made of solid unbleached sulfate (SUS®) paperboard and may further including a coating, such as a clay coating. However, any suitable paperboard or other material may be used and may include any suitable coating or no coating. More details of a panel 110 for forming a three-compartment food carton insert 100 are shown and described hereinbelow with reference to FIG. 3.

Referring now to FIG. 2 is a perspective view of the three-compartment food carton insert 100 shown in FIG. 1 installed in a food carton (or container) 200. Food carton (or container) 200 may be any type of disposable or non-disposable container, such as, but not limited to, a paperboard container, a Styrofoam container, a plastic container, a glass container, a metal container, and the like.

In the example shown in FIG. 2, food carton (or container) 200 may be a disposable paperboard food carton (e.g., carry-out/to-go food container). In this example, food carton (or container) 200 may be a substantially rectangular food carton that may include a bottom panel 210, four side panels 212, closure flaps 214, and corner gussets 216. Together, the bottom panel 210, the four side panels 212, and the closure flaps 214 form a single inner compartment 218. Three-compartment food carton insert 100 is sized to fit within inner compartment 218 of food carton (or container) 200. For example, three-compartment food carton insert 100 may be easily placed in the space of inner compartment 218, thereby rendering the one large space of inner compartment 218 into multiple (e.g., three) food compartments (e.g., food compartments 115A, 115B, 115C).

In the example of the three-compartment food carton insert 100, three food items (e.g., tacos, hotdogs, etc.) may be placed in food carton (or container) 200 and wherein three-compartment food carton insert 100 provides a means for keeping the three food items separate.

Food carton (or container) 200 is not limited to a substantially rectangular shape. Food carton (or container) 200 may be of a number of overall general shapes including, but not limited to, square, rectangular, pyramidal, triangular, circular, oval, or any other suitable shape. Accordingly, the footprint of any food carton insert 100 may be designed to correlate to any shape of food carton (or container) 200.

Referring now to FIG. 3 is a plan view of the three-compartment food carton insert 100 shown in FIG. 1 and FIG. 2 in a flat unfolded configuration. With respect to forming, for example, paperboard products, this flat unfolded configuration may also be referred to as a “blank.” The precise width and length of panel 110 depends on the number of dividers 120 to be provided and the size of the floor (e.g., bottom panel 210) of the container in which it will be used. In this example, panel 110 may include two dividers 120 and is sized to fit within a container whose floor may be about 5.5 inches wide and about 7.75 inches long.

More specifically in this example, panel 110 (in blank form) may have an overall width of about 5 5/16 inches and an overall length of about 14 3/32 inches. Certain portions of panel 110 correspond to food compartments 115A, 115B, 115C and certain other portions of panel 110 correspond to dividers 120A, 120B. For example and in order, a portion 130 corresponds to food compartment 115A, portions 132 and 134 correspond to divider 120A, a portion 136 corresponds to food compartment 115B, portions 138 and 140 correspond to divider 120B, and a portion 142 corresponds to food compartment 115C.

Wherein panel 110 (in blank form) is foldable to form the finished product, the various portions are defined by certain fold lines. For example, a fold line 150 is the boundary between portion 130 and portion 132, a fold line 152 is the boundary between portion 132 and portion 134, a fold line 154 is the boundary between portion 134 and portion 136, a fold line 156 is the boundary between portion 136 and portion 138, a fold line 158 is the boundary between portion 138 and portion 140, and a fold line 160 is the boundary between portion 140 and portion 142.

In each embodiment of the panel 110 (in blank form), the panel 110 may define a first end 111A opposite a second end 111B.

In this example, and referring still to FIG. 3, the length of each of the portions 130, 136, and 142 may be about 2 17/32 inches. Further, the length of each of the portions 132, 134, 138, and 140 may be about 1⅝ inches.

Fold line 150, fold line 152, and fold line 154 may be used to form divider 120A. Accordingly, fold lines 150 and 154 may be considered the lower fold lines of divider 120A, while fold line 152 may be considered the upper fold line of divider 120A. Likewise, fold line 156, fold line 158, and fold line 160 may be used to form divider 120B. Accordingly, fold lines 156 and 160 may be considered the lower fold lines of divider 120B, while fold line 158 may be considered the upper fold line of divider 120B.

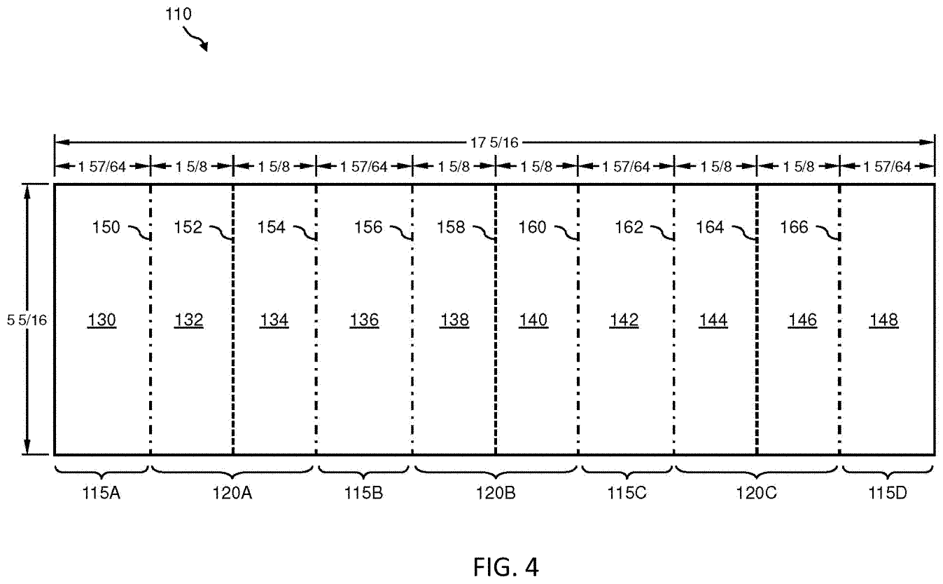

Referring now to FIG. 4 is a plan view of another example of the presently disclosed food carton insert 100 in a flat pre-folded configuration for providing multiple food compartments in a food container, which is a four-compartment food carton insert 100. In the example of the four-compartment food carton insert 100, food carton insert 100 may include four food compartments 115 (e.g., food compartments 115A, 115B, 115C, 115D) separated by three dividers 120 (e.g., dividers 120A, 120B, 120C). The four-compartment food carton insert 100 may be installed in food carton (or container) 200.

Four-compartment food carton insert 100 may be easily placed in the space of inner compartment 218, thereby rendering the one large space of inner compartment 218 into multiple (e.g., four) food compartments (e.g., food compartments 115A, 115B, 115C, 115D). For example, four food items (e.g., tacos, hotdogs, etc.) may be placed in food carton (or container) 200 and wherein four-compartment carton insert 100 provides a means for keeping the four food items separate.

Again, the precise width and length of panel 110 depends on the number of dividers 120 to be provided and the size of the floor (e.g., bottom panel 210) of the container in which it will be used. In this example, panel 110 includes three dividers 120 and is sized to fit within a container whose floor may be about 5.5 inches wide and about 7.75 inches long.

More specifically in this example, panel 110 (in blank form) may have an overall width of about 5 5/16 inches and an overall length of about 17 5/16 inches. Certain portions of panel 110 correspond to food compartments 115A, 115B, 115C, 115D and certain other portions of panel 110 correspond to dividers 120A, 120B, 120C. For example and in order, a portion 130 corresponds to food compartment 115A, portions 132 and 134 correspond to divider 120A, a portion 136 corresponds to food compartment 115B, portions 138 and 140 correspond to divider 120B, a portion 142 corresponds to food compartment 115C, portions 144 and 146 correspond to divider 120C, and a portion 146 corresponds to food compartment 115D.

Wherein panel 110 (in blank form) is foldable to form the finished product, the various portions are defined by certain fold lines. For example, a fold line 150 is the boundary between portion 130 and portion 132, a fold line 152 is the boundary between portion 132 and portion 134, a fold line 154 is the boundary between portion 134 and portion 136, a fold line 156 is the boundary between portion 136 and portion 138, a fold line 158 is the boundary between portion 138 and portion 140, a fold line 160 is the boundary between portion 140 and portion 142, a fold line 162 is the boundary between portion 142 and portion 144, a fold line 164 is the boundary between portion 144 and portion 146, and a fold line 166 is the boundary between portion 146 and portion 148.

In this example and referring still to FIG. 4, the length of each of the portions 130, 136, 142, and 148 may be about 1 57/64 inches. Further, the length of each of the portions 132, 134, 138, 140, 144, and 146 may be about 1⅝ inches.

Fold line 150, fold line 152, and fold line 154 may be used to form divider 120A. Accordingly, fold lines 150 and 154 may be considered the lower fold lines of divider 120A, while fold line 152 may be considered the upper fold line of divider 120A. Likewise, fold line 156, fold line 158, and fold line 160 may be used to form divider 120B. Accordingly, fold lines 156 and 160 may be considered the lower fold lines of divider 120B, while fold line 158 may be considered the upper fold line of divider 120B. Likewise, fold line 162, fold line 164, and fold line 166 may be used to form divider 120C. Accordingly, fold lines 162 and 166 may be considered the lower fold lines of divider 120C, while fold line 164 may be considered the upper fold line of divider 120C.

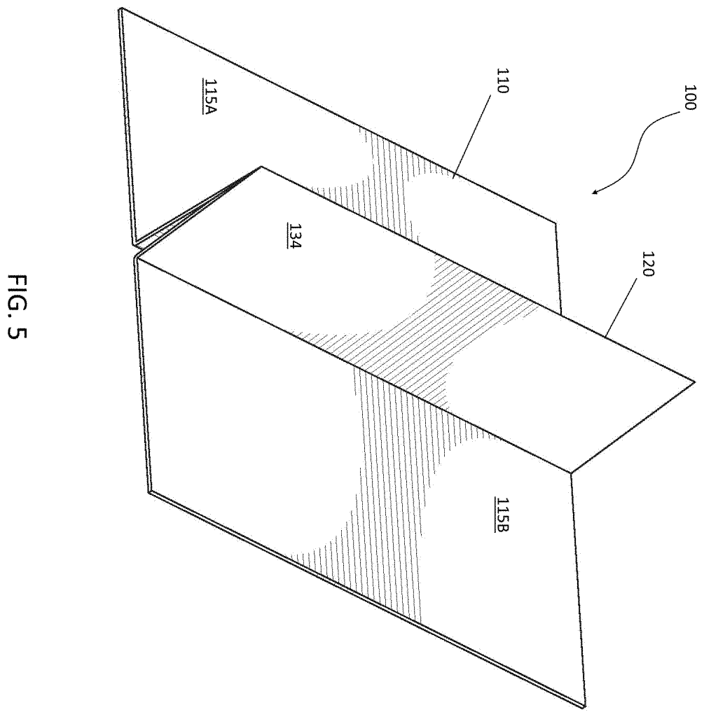

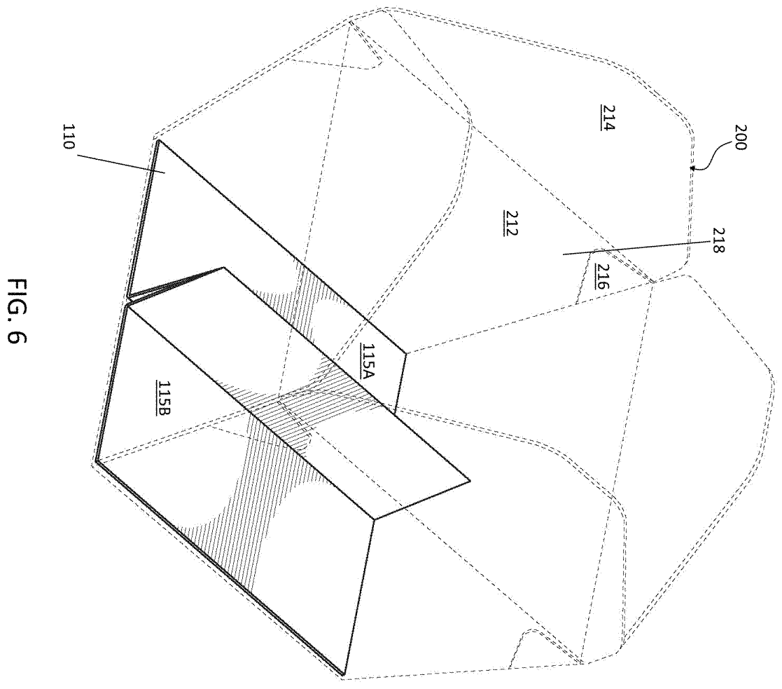

Referring now to FIG. 5 is a perspective view of yet another example of the presently disclosed food carton insert 100 for providing multiple food compartments in a food container, which is a two-compartment food carton insert 100 according to a simplest configuration. In the example of the two-compartment food carton insert 100, food carton insert 100 may include two food compartments 115 (e.g., food compartments 115A, 115B) separated by one divider 120. Two-compartment food carton insert 100 may be easily placed in the space of inner compartment 218, as depicted in FIG. 6, thereby rendering the one large space of inner compartment 218 into multiple (e.g., two) food compartments (e.g., food compartments 115A, 115B). For example, two food items (e.g., tacos, hotdogs, etc.) may be placed in food carton (or container) 200 and wherein two-compartment carton insert 100 provides a means for keeping the two food items separate.

The descriptions herein of the two-compartment, three-compartment and four-compartment food carton inserts 100 may be easily used by one skilled in the art to additionally create, without undue experimentation, five-compartment, six-compartment, and/or seven or more-compartment food carton inserts 100. The panels 110 of FIGS. 3 and 4 would be extended to allow for additional food compartments 115, dividers 120 and additional fold lines, so that an insert 100 may be constructed.

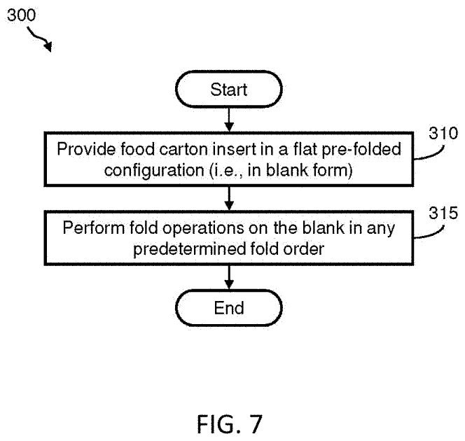

Referring now to FIG. 7 is a flow diagram of an example of a method 300 of making the presently disclosed food carton insert 100 for providing multiple food compartments in a food container. Method 300 may include, but is not limited to, the following steps.

At a step 310, the presently disclosed food carton insert is provided in a flat unfolded configuration (in blank form). In one example, the paperboard panel 110 (in blank form) that corresponds to the three-compartment food carton insert 100, as shown in FIG. 3, is provided. In another example, panel 110 (in blank form) that corresponds to the four-compartment food carton insert 100, as shown in FIG. 4, is provided. In yet another example, panel 110 (in blank form) that corresponds to the two-compartment food carton insert 100, as show in FIG. 5, is provided. In other examples, other panels 110 (in blank form) that correspond to five or more compartment food carton inserts 100 are provided.

At a step 315, fold operations are performed on panel 110 in any predetermined fold order. In one example, and referring now to panel 110 (in blank form) shown in FIG. 3, a 90-degree fold is performed at fold line 150, in a first direction, then a 180-degree fold is performed at fold line 152, in a second direction opposite the first direction, then a 90-degree fold is performed at fold line 154, in the first direction, then a 90-degree fold is performed at fold line 156, in the first direction, then a 180-degree fold is performed at fold line 158, in the second direction, and then a 90-degree fold is performed at fold line 160, in the first direction. In one example, the folded panels (e.g., 132, 134) may be glued, taped, or otherwise adhered together to hold in the folded configuration to form the dividers (e.g. 120A). An adhesive may be applied to one or both of the opposing panels (e.g., 132, 134) and pressure may be applied to the two opposing panels (e.g., 132, 134) so that the adhesive may adhere the two opposing panels (e.g., 132, 134) together.

To aid the manufacturing process, the panels 110 (in blank form) may be indented, perforated and/or scored along one or more fold lines 150, 152, 154, 156, 158, 160, 162, 164, 166. If indented and/or scored along multiple fold lines 150, 152, 154, 156, 158, 160, 162, 164, 166, one side of the panel 110 (in blank form) may be indented and/or scored for one or more of the panels 150, 154, 156, 160, 162, 166, and on an opposite side of the panel 110 (in blank form) one or more of the remaining panels 152, 158, 164 may be indented and/or scored, thereby ensuring that the indentions and/or scores appropriately aid the folding in the corresponding direction.

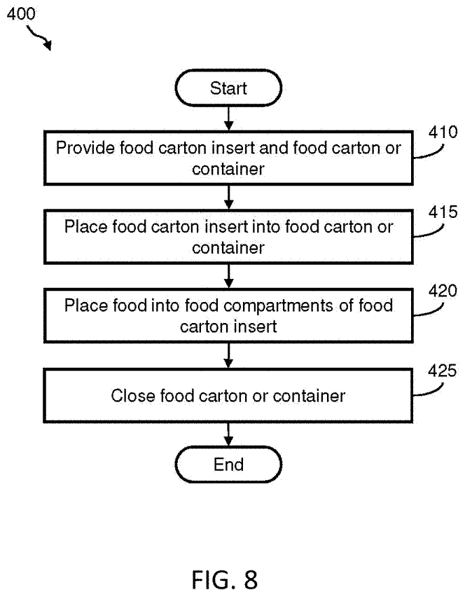

Referring now to FIG. 8 is a flow diagram of an example of a method 400 of using the presently disclosed food carton insert 100 for providing multiple food compartments in a food container. Method 400 may include, but is not limited to, the following steps.

At a step 410, any configuration of the presently disclosed food carton insert 100 is provided along with any food carton or container. In one example, the two-compartment food carton insert 100 shown in FIG. 7 is provided along with food carton (or container) 200. In another example, the three-compartment food carton insert 100 shown in FIG. 1 is provided along with food carton (or container) 200. In another example, the four-compartment food carton insert 100 shown in FIG. 4 is provided along with food carton (or container) 200. In other examples, other panels 110 (in blank form) that correspond to two or five or more compartment food carton inserts 100 are provided.

At a step 415, the presently disclosed food carton insert 100 is placed into the food carton or container. In one example, the three-compartment food carton insert 100 is placed inside food carton (or container) 200 as shown in FIG. 2. In another example, the four-compartment food carton insert 100 is placed inside food carton (or container) 200 as shown in FIG. 5. In other examples, other panels 110 (in blank form) that correspond to two or five or more compartment food carton inserts 100 are placed inside food cartons (or containers) 200.

At a step 420, food items may be place into the food compartments of the presently disclosed food carton insert 100. In one example, and referring to the three-compartment food carton insert 100 and food carton (or container) 200 shown in FIG. 2, three tacos are placed in three-compartment food carton insert 100. For example, one taco or hotdog is placed in food compartment 115A of three-compartment food carton insert 100. Then, another taco or hotdog is placed in food compartment 115B of three-compartment food carton insert 100. Then, another taco or hotdog is placed in food compartment 115C of three-compartment food carton insert 100. In other examples, placement of food items may occur in four-compartment, two-compartment or other inserts 100.

At a step 425, the food carton or container is closed. In one example, the closure flaps 214 of food carton (or container) 200 are closed.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments ±100%, in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

The invention claimed is:

1. A method of making a food carton insert, comprising:
providing a substantially continuous sheet of paperboard having a first end and a second end opposite the first end;
folding the paperboard at a first fold line at a 90-degree angle in a first direction;
folding the paperboard at a second fold line at a 180-degree angle in a second direction being opposite the first direction;
folding the paperboard at a third fold line at a 90-degree angle in the first direction for creating a divider between the first fold line and the third fold line,
thereby creating a first food compartment left of the divider and a second food compartment right of the divider.

2. The method of claim 1, wherein the third fold line fold is folded after the second fold line fold, which is folded after the first fold line fold.

3. The method of claim 1, further comprising applying adhesive to at least one of opposing panels of the paperboard extending from the second fold line, and then applying pressure to at least one of the opposing panels to adhere the opposing panels together.

4. The method of claim 1, further comprising indenting or scoring the first fold line and the third fold line on a top side of the paperboard.

5. The method of claim 4, further comprising indenting or scoring the second fold line on a bottom side of the paperboard.

6. The method of claim 1, further comprising perforating one of more of the fold lines of the paperboard.

7. The method of claim 1, further comprising:
folding the paperboard at a fourth fold line at a 90-degree angle in the first direction;
folding the paperboard at a fifth fold line at a 180-degree angle in the second direction;
folding the paperboard at a sixth fold line at a 90-degree angle in the first direction for creating a second divider between the fourth fold line and the sixth fold line,
thereby creating a third food compartment right of the second divider.

8. The method of claim 7, further comprising:
folding the paperboard at a seventh fold line at a 90-degree angle in the first direction;
folding the paperboard at an eight fold line at a 180-degree angle in the second direction;
folding the paperboard at a ninth fold line at a 90-degree angle in the first direction for creating a third divider between the seventh fold line and the ninth fold line,
thereby creating a fourth food compartment right of the third divider.

9. A method of using the food carton insert of claim 1, comprising:
placing the food carton insert into a food carton or container;
placing food in one or more of the compartments;
closing the food carton or container.

10. A method of using the food carton insert of claim 4, comprising:
placing the food carton insert into a food carton or container;
placing food in one or more of the compartments;
closing the food carton or container.

11. A method of using the food carton insert of claim 5, comprising:
placing the food carton insert into a food carton or container;
placing food in one or more of the compartments;
closing the food carton or container.
